(19) United States
(12) Patent Application Publication
(10) Pub. No.: US 2009/0247670 A1
(43) Pub. Date: Oct. 1, 2009

(54) Epoxy Resin Molding Material for Sealing, and Electronic Component Device

(76) Inventors: Mitsuyoshi Hamada, Chiba (JP); Akira Nagai, Ibaraki (JP); Mitsuo Katayose, Ibaraki (JP); Kazuyoshi Tendou, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/094,532

(22) PCT Filed: Nov. 16, 2006
(86) PCT No.: PCT/JP2006/322861

§ 371 Date: May 21, 2008

(30) Foreign Application Priority Data
Nov. 21, 2005 (JP) 2005-335619
Sep. 19, 2006 (JP) 2006-253356

(51) Int. Cl. C08L 63/00; C08L 95/00

(52) U.S. Cl. 523/450; 523/400; 523/458

(57) ABSTRACT

The invention relates to an epoxy resin molding material for sealing, comprising an epoxy resin (A), a curing agent (B), and a colorant resin mixture (C) wherein a resin (C1) and a colorant (D) having an electric resistivity of 1×10⁵Ω·cm or more are beforehand mixed with each other. This can provide an epoxy resin molding material for sealing which is good in moldabilities such as fluidity and curability, and colorability, and which does not cause a short circuit failure based on an electroconductive material even when the material is used in a package wherein the distance between pads or wires is small; and an electronic component device equipped with an element sealed therewith.

### TECHNICAL FIELD

The present invention relates to an epoxy resin molding material for sealing, and an electronic component device equipped with an element sealed with this epoxy resin molding material for sealing.

### BACKGROUND ART

Hitherto, in the field of the sealing of elements in electronic component devices, such as transistors or ICs, resin-sealing has become a main current from the viewpoint of productivity, and costs and others, and epoxy resin molding materials have widely been used. The reason therefor is that epoxy resin has well-balanced various properties, such as electric characteristics, moisture resistance, heat resistance, mechanical characteristics, and adhesion to inserting articles.

As the mounting of electronic component devices onto a printed wiring board has been performed to give a higher mount density in recent years, the main current of the electronic component device form has been converted from conventional pin-inserted packages to surface-mounted packages. About surface-mounted ICs, LSIs, or the like, the package thereof has been made thin and small in order to make the mount density high and make the mount height low. Thus, the occupation volume of the elements in the package has turned large and the thickness of the package has become very small.

Moreover, in order to cope with a further reduction in the size and the weight of packages, the form of the packages has been shifting from a QFP (quad flat package), an SOP (small outline package), and others to area-mounted packages, such as BGAs (ball grid arrays), an example of which is a CSP (chip size package) making it possible to be easy to correspond to larger number of pins and to attain amounting which gives a higher mount density. About these packages, in recent years, new structure packages have been developed to realize high-speed and multi-function, examples of the packages including structures of a facedown type, stacked type, flip chip type, and wafer level type. However, many of them are in the form of a singe-surface sealed package in which only a single face, which is an element-mounting surface, is sealed with a sealing material such as an epoxy resin molding material and then solder balls are formed on the rear surface to joint the package to a circuit board.

As the size of such packages has been made smaller and the number of pins therein has been made larger, the distance between pitches, such as inner leads, pads, or wires, has acceleratedly become narrow. For this reason, there has been caused a problem that: carbon black itself, which has been conventionally used as a colorant for sealing material, has electroconductivity; thus, aggregates thereof enter gaps between inner leads, between pads or between wires so that electrical characteristic poorness is caused.

As a result, the following have been investigated: methods of using an organic dye, an organic pigment, and an inorganic pigment, such as a composite oxide, instead of carbon black (see, for example, Japanese Patent Application Laid-Open Nos. 60-119760, 63-179921, 11-60904, and 2003-160713).

### DISCLOSURE OF THE INVENTION

However, methods as described above have problems such as the reduction of fluidity, the colorability and the curability fall and high costs. Thus, the methods do not attain to a satisfactory level. The present invention has been made in light of such a situation. The invention provides an epoxy resin molding material for sealing which is good in moldabilities such as fluidity and curability, and colorability, and does not give a failure based on a short circuit even if the molding material is used in an electronic component device such as a semiconductor package wherein the distance between pads or wires is small; and an electronic component device equipped with an element sealed with this material.

The inventors have repeated eager investigations to solve the above-mentioned problems, so as to find out that the object can be attained by means of an epoxy resin molding material, for sealing, using a colorant resin mixture wherein a colorant having a specific electric characteristic is mixed with a resin in advance. Thus, the present invention has been made.

The invention relates to the following items 1 to 13:

1. An epoxy resin molding material for sealing, comprising:

an epoxy resin (A),

a curing agent (B), and

a colorant resin mixture (C) wherein a resin (C1) and a colorant (D) having an electric resistivity of 1×10⁵Ω·cm or more are beforehand mixed with each other.

2. The epoxy resin molding material for sealing according to item 1, wherein the resin (C1) in the colorant resin mixture (C) is at least one of the epoxy resin (A) and the curing agent (B).

3. The epoxy resin molding material for sealing according to item 1 or 2, further comprising a colorant (D) which gives an electric resistivity of 1×10⁵Ω·cm or more by itself.

4. The epoxy resin molding material for sealing according to any one of items 1 to 3, wherein the colorant (D) is one or more selected from pitch, phthalocyanine dyes, phthalocyanine pigments, aniline black, perylene black, black iron oxide, and black titanium oxide.

5. The epoxy resin molding material for sealing according to item 4, wherein the colorant (D) is pitch.

6. The epoxy resin molding material for sealing according to item 4 or 5, wherein the pitch is made of mesophase microspheres separated from mesophase pitch.

7. The epoxy resin molding material for sealing according to any one of items 4 to 6, wherein the carbon content by percentage in the pitch is from 88 to 96% by mass.

8. The epoxy resin molding material for sealing according to any one of items 4 to 7, wherein the amount of the pitch in the colorant resin mixture (C) is 30% or more by mass of the total of the colorant (D) in the colorant resin mixture (C).

9. The epoxy resin molding material for sealing according to any one of items 1 to 8, wherein the amount of the colorant in the colorant resin mixture (C) is 50% or more by mass of the total of the colorant (D) in the epoxy resin molding material.

10. The epoxy resin molding material for sealing according to any one of items 1 to 9, wherein the total amount of the colorant (D) is from 2 to 20 parts by mass for 100 parts by mass of the epoxy resin (A).

11. The epoxy resin molding material for sealing according to any one of items 1 to 10, wherein the epoxy resin (A) is one or more selected from biphenyl type epoxy resin, bisphenol F type epoxy resin, thiodiphenol type epoxy resin, phenol/aralkyl type epoxy resin, and naphthol/aralkyl type epoxy resin.

12. The epoxy resin molding material for sealing according to any one of items 1 to 11, wherein the curing agent (B) is one or more selected from phenol/aralkyl resin and naphthol/aralkyl resin each represented by the following general formula (I) or (II):

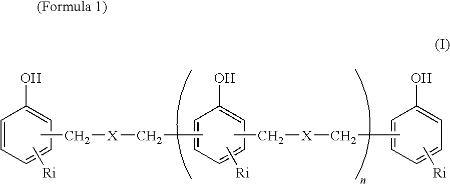

wherein Rs (═R's) are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

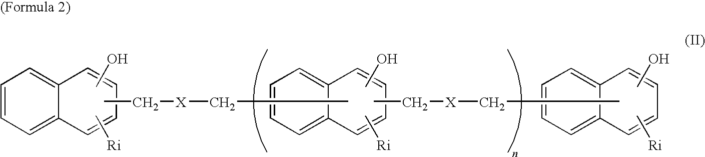

wherein Rs are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

13. An electronic component device, equipped with an element sealed with the epoxy resin molding material for sealing according to any one of items 1 to 12.

The disclosure of the present application is relevant to subject matters described in Japanese Patent Application No. 2005-335619 filed on Nov. 21, 2005 and Japanese Patent Application No. 2006-253356 filed on Sep. 19, 2006, and the contents disclosed therein are incorporated herein by reference.

### BEST MODE FOR CARRYING OUT THE INVENTION

The epoxy resin (A) used in the invention is not particularly limited as long as the resin is a resin having, in a single molecule thereof, two or more epoxy groups. Examples thereof include epoxidized Novolak resins each obtained by condensing or cocondensing a phenol, such as phenol, cresol, xylenol, resorcin, catechol, bisphenol A or bisphenol F, and/or a naphthol, such as α-naphthol, β-naphthol or dihydroxynaphthalene, with a compound having an aldehyde group, such as formaldehyde, acetaldehyde, propionaldehyde, benzaldehyde or salicylaldehyde, in the presence of an acidic catalyst, typical examples of the resins being phenol Novolak type epoxy resin, o-cresol Novolak type epoxy resin, and epoxy resin having a triphenylmethane skeleton;

diglycidyl ethers such as bisphenol A, bisphenol F, bisphenol S, biphenol, and thiodiphenol, each of which may be alkyl-substituted, aromatic-ring-substituted, or unsubstituted;

stylbene type epoxy resins;

hydroquinone type epoxy resins;

glycidyl ester type epoxy resins each obtained by reaction of a polybasic acid, such as fumaric acid or dimer acid, with epichlorohydrin;

glycidylamine type epoxy resins each obtained by reaction of a polyamine, such as diaminodiphenylmethane or isocyanuric acid, with epichlorohydrin;

epoxidized cocondensed resins each made from dicyclopentadiene and a phenol;

epoxy resins having a naphthalene ring;

epoxidized aralkyl type phenol resins each synthesized from a phenol and/or a naphthol, and dimethoxy-p-xylene or bis(methoxymethyl)biphenyl, examples of the resins being phenol/aralkyl resin, and naphthol/aralkyl resin;

trimethylolpropane type epoxy resins;

terpene modified epoxy resins;

linear aliphatic epoxy resins each obtained by oxidizing olefin bonds with a peracid such as acetic peracid;

alicyclic epoxy resins; and

sulfur-atom-containing epoxy resins. These may be used alone or in combination of two or more thereof.

The molding material in particular preferably contains a biphenyl type epoxy resin, which is diglycidyl ether of biphenol which may be alkyl-substituted, aromatic-ring-substituted or unsubstituted from the viewpoint of compatibility between fluidity and curability. From the viewpoint of compatibility between fluidity and flame retardancy, the molding material preferably contains a bisphenol F type epoxy resin, which is diglycidyl ether of bisphenol F which may be alkyl-substituted, aromatic-ring-substituted or unsubstituted. From the viewpoint of compatibility between fluidity and reflowability, the molding material preferably contains a thiodiphenol type epoxy resin, which is diglycidyl ether of thiodiphenol which may be alkyl-substituted, aromatic-ring-substituted or unsubstituted. From the viewpoint of curability and flame retardancy, the molding material preferably contains an epoxidized phenol/aralkyl resin synthesized from phenol which may be alkyl-substituted, aromatic-ring-substituted or unsubstituted, and bis(methoxymethyl)biphenyl. From the viewpoint of compatibility between storage stability and flame retardancy, the molding material preferably contains an epoxidized naphthol/aralkyl resin synthesized from a naphthol which may be alkyl-substituted, aromatic-ring-substituted or unsubstituted, and dimethoxy-p-xylene.

The biphenyl type epoxy resin is, for example, an epoxy resin represented by the following general formula (III):

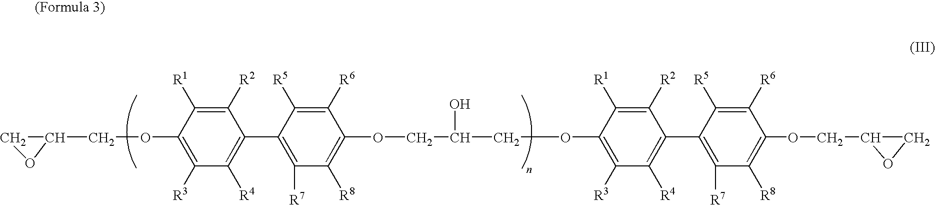

wherein R¹ (s) to R⁸ (s) are selected from hydrogen atoms and substituted or unsubstituted monovalent hydrocarbon groups having 1 to 10 carbon atoms, and may be wholly the same or different; and n represents 0 or an integer of 1 to 3.

The biphenyl type epoxy resin represented by the general formula (III) can be obtained by causing a biphenol compound to react with epichlorohydrin in a known manner. R¹ (s) to R⁸ (s) in the general formula (III) are each, for example, a hydrogen atom, an alkyl group having 1 to 10 carbon atoms, such as a methyl, ethyl, propyl, butyl, isopropyl, isobutyl or tert-butyl group, or an alkenyl group having 1 to 10 carbon atoms, such as a vinyl, allyl or butenyl group. Particularly preferred is a hydrogen atom or a methyl group. Examples of such an epoxy resin include epoxy resin made mainly of 4,4′-bis(2,3-epoxypropoxy)biphenyl or 4,4′-bis(2,3-epoxypropoxy)-3,3′,5,5′-tetramethylbiphenyl, and epoxy resin obtained by causing epichlorohydrin to react with 4,4′-biphenol or 4,4′-(3,3′,5,5′-tetramethyl)biphenol. Particularly preferred is epoxy resin made mainly of 4,4′-bis(2,3-epoxypropoxy)-3,3′,5,5′-tetramethylbiphenyl. Such an epoxy resin can be gained as a product (trade name: YX-4000) manufactured by Japan Epoxy Resins Co., Ltd. as a commercially available product. The blend amount of the biphenyl type epoxy resin is preferably 20% or more by mass of the total of the epoxy resin, more preferably 30% or more by mass thereof, even more preferably 50% or more by mass thereof in order to exhibit the performance of the resin.

The bisphenol F type epoxy resin is, for example, an epoxy resin represented by the following general formula (IV):

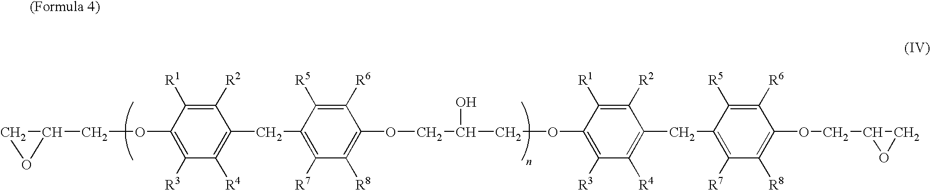

wherein R¹ (s) to R⁸ (s) are selected from hydrogen atoms and substituted or unsubstituted monovalent hydrocarbon groups having 1 to 10 carbon atoms, and may be wholly the same or different; and n is 0 or an integer of 1 to 3.

The bisphenol F type epoxy resin represented by the general formula (IV) can be obtained by causing a bisphenol F compound to react with epichlorohydrin in a known manner. R¹ (s) to R⁸ (s) in the general formula (IV) are each, for example, a hydrogen atom, an alkyl group having 1 to 10 carbon atoms, such as a methyl, ethyl, propyl, butyl, isopropyl, isobutyl or tert-butyl group, or an alkenyl group having 1 to 10 carbon atoms, such as a vinyl, allyl or butenyl group. Particularly preferred is a hydrogen atom or a methyl group. Examples of such an epoxy resin include epoxy resin made mainly of diglycidylether of 4,4′-methylenebis (2,6-dimethylphenol), epoxy resin made mainly of diglycidyl ether of 4,4′-methylenebis(2,3,6-trimethylphenol), and epoxy resin made mainly of diglycidylether of 4,4′-methylenebisphenol. Particularly preferred is epoxy resin made mainly of diglycidyl ether of 4,4′-methylenebis (2,6-dimethylphenol). Such a resin can be gained as a product (trade name: YSLV-80XY) manufactured by Nippon Steel Chemical Co., Ltd. as a commercially available product. The blend amount of the bisphenol F type epoxy resin is preferably 20% or more by mass of the total of the epoxy resin, more preferably 30% or more by mass thereof, even more preferably 50% or more by mass thereof in order to exhibit the performance of the resin.

The thiodiphenol type epoxy resin is, for example, an epoxy resin represented by the following general formula (V):

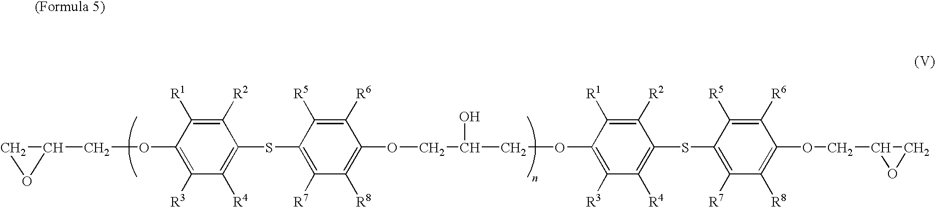

wherein R¹ (s) to R⁸ (s) are selected from hydrogen atoms and substituted or unsubstituted monovalent hydrocarbon groups having 1 to 10 carbon atoms, and may be wholly the same or different; and n is 0 or an integer of 1 to 3.

The thiodiphenol type epoxy resin represented by the general formula (V) can be obtained by causing a thiodiphenol compound to react with epichlorohydrin in a known manner. R¹ (s) to R⁸ (s) in the general formula (V) are each, for example, a hydrogen atom, an alkyl group having 1 to 10 carbon atoms, such as a methyl, ethyl, propyl, butyl, isopropyl, isobutyl or tert-butyl group, or an alkenyl group having 1 to 10 carbon atoms, such as a vinyl, allyl or butenyl group. Particularly preferred is a hydrogen atom, or a methyl or tert-butyl group. Examples of such an epoxy resin include epoxy resin made mainly of diglycidyl ether of 4,4′-dihydroxydiphenylsulfide, epoxy resin made mainly of diglycidyl ether of 2,2′,5,5′-tetramethyl-4,4′-dihydroxydiphenylsulfide, and epoxy resin made mainly of diglycidyl ether of 2,2′-dimethyl-4,4′-dihydroxy-5,5′-di-tert-butyldiphenylsulfide. Particularly preferred is epoxy resin made mainly of epoxy resin made mainly of diglycidyl ether of 2,2′-dimethyl-4,4′-dihydroxy-5,5′-di-tert-butyldiphenylsulfide. Such a resin can be gained as a product (trade name: YSLV-120TE) manufactured by Nippon Steel Chemical Co., Ltd. as a commercially available product. The blend amount of the thiodiphenol type epoxy resin is preferably 20% or more by mass of the total of the epoxy resin, more preferably 30% or more by mass thereof, even more preferably 50% or more by mass thereof in order to exhibit the performance of the resin.

The epoxidized phenol/aralkyl resin is, for example, an epoxy resin represented by the following general formula (VI):

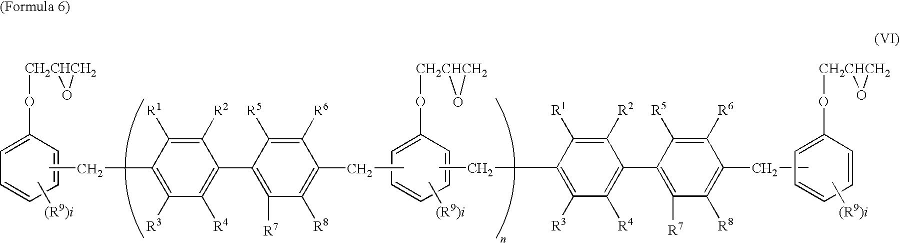

wherein R¹ (s) to R⁹ (s) are selected from hydrogen atoms and substituted or unsubstituted monovalent hydrocarbon groups having 1 to 12 carbon atoms, and may be wholly the same or different; i represents 0 or an integer of 1 to 3; and n is 0 or an integer of 1 to 10.

The epoxidized, biphenylene-skeleton-containing phenol/aralkyl resin represented by the general formula (VI) can be obtained by causing a phenol/aralkyl resin synthesized from a substituted or unsubstituted phenol and bis(methoxymethyl)biphenyl to react with epichlorohydrin in a known manner.

R¹ (s) to R⁹ (s) in the general formula (VI) are each, for example, a linear alkyl group, such as a methyl, ethyl, propyl, isopropyl, n-butyl, sec-butyl, tert-butyl, pentyl, hexyl, octyl, decylordodecyl group, a cyclic alkyl group such as a cyclopentyl, cyclohexyl, cycloheptyl, cyclopentenyl or cyclohexenyl group, an aryl-group-substituted alkyl group such as a benzyl or phenethyl group, an alkoxy-group-substituted alkyl group such as a methoxy-group-substituted alkyl group, ethoxy-group-substituted alkyl group or butoxy-group-substituted alkyl group, an amino-group-substituted alkyl group such as an aminoalkyl, dimethylaminoalkyl or diethylaminoalkyl group, a hydroxyl-group-substituted alkyl group, an unsubstituted aryl group such as a phenyl, naphthyl or biphenyl group, an alkyl-group-substituted aryl group such as a tolyl, dimethylphenyl, ethylphenyl, butylphenyl, tert-butylphenyl or dimethylnaphthyl group, an alkoxy-group-substituted aryl group such as a methoxyphenyl, ethoxyphenyl, butoxyphenyl, tert-butoxyphenyl or methoxynaphthyl group, an amino-group-substituted aryl group such as an aminoalkyl, dimethylaminoalkyl or diethylaminoalkyl group, or a hydroxyl-group-substituted aryl group. Particularly preferred is a hydrogen atom or a methyl group. The resin is, for example, an epoxidized phenol/aralkyl resin represented by a general formula (VII) illustrated below. The symbol n represents 0 or an integer of 1 to 10, and is more preferably 6 or less on average. Such resins can be gained as a product (trade name: NC-3000S) manufactured by Nippon Kayaku Co., Ltd. and a product (trade name: CER-3000L) manufactured by the same company (a mixture composed of a phenol/aralkyl resin of the general formula (VII) and 4,4′-bis(2,3-epoxypropoxy)biphenyl at a blend ratio by mass of 8/2) as commercially available products.

The blend amount of the epoxidized phenol/aralkyl resin is preferably 20% or more by mass of the total of the epoxy resin, more preferably 30% or more by mass thereof, even more preferably 50% or more by mass thereof in order to exhibit the performance of the resin.

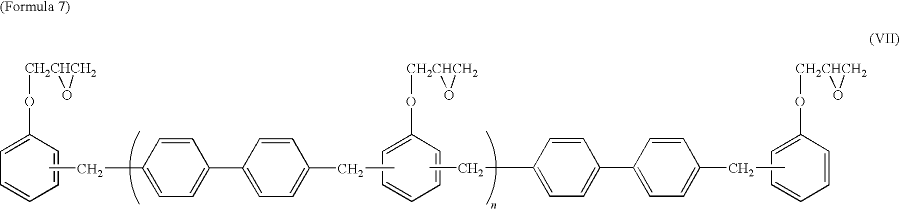

wherein n represents 0 or an integer of 1 to 10.

The epoxidized naphthol/aralkyl resin is, for example, an epoxy resin represented by the following general formula (VIII):

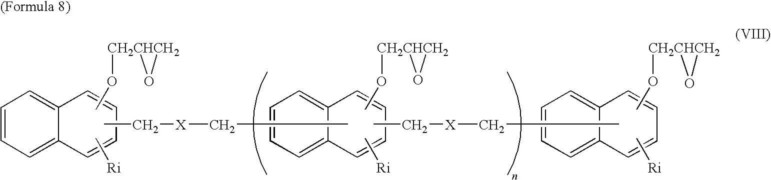

wherein Rs are selected from hydrogen atoms and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

The epoxidized naphthol/aralkyl resin represented by the general formula (VIII) can be obtained by causing a naphthol/aralkyl resin synthesized from substituted or unsubstituted naphthol and dimethoxy-p-xylene or bis(methoxymethyl) to react with epichlorohydrin in a known manner.

Rs in the general formula (VIII) are each, for example, a linear alkyl group, such as a methyl, ethyl, propyl, isopropyl, n-butyl, sec-butyl, tert-butyl, pentyl, hexyl, octyl, decylordodecyl group, a cyclic alkyl group and a cyclic alkenyl group such as a cyclopentyl, cyclohexyl, cycloheptyl, cyclopentenyl or cyclohexenyl group, an aryl-group-substituted alkyl group such as a benzyl or phenethyl group, an alkoxy-group-substituted alkyl group such as a methoxy-group-substituted alkyl group, ethoxy-group-substituted alkyl group or butoxy-group-substituted alkyl group, an amino-group-substituted alkyl group such as an aminoalkyl, dimethylaminoalkyl or diethylaminoalkyl group, a hydroxyl-group-substituted alkyl group, an unsubstituted aryl group such as a phenyl, naphthyl or biphenyl group, an alkyl-group-substituted aryl group such as a tolyl, dimethylphenyl, ethylphenyl, butylphenyl, tert-butylphenyl or dimethylnaphthyl group, an alkoxy-group-substituted aryl group such as a methoxyphenyl, ethoxyphenyl, butoxyphenyl, tert-butoxyphenyl or methoxynaphthyl group, an amino-group-substituted aryl group such as an aminoaryl, dimethylaminoaryl or diethylaminoaryl group, or a hydroxyl-group-substituted aryl group. In particular, Rs are each preferably a hydrogen atom or a methyl group. The resin is, for example, an epoxidized naphthol/aralkyl resin represented by a general formula (IX) or (X) illustrated below.

X(s)(each) represent(s) an aromatic-ring-containing bivalent organic group, and examples thereof include arylene groups, such as phenylene, biphenylene and naphthylene groups, alkyl-group-substituted arylene groups, such as a tolylene group, alkoxy-group-substituted arylene groups, aralkyl-group-substituted arylene groups, bivalent groups each obtained from an aralkyl group, such as benzyl and phenethyl groups, and bivalent groups each containing an arylene group, such as a xylylene group. Particularly preferred is a phenylene group from the viewpoint of compatibility between storage stability and flame retardancy.

The symbol n represents 0 or an integer of 1 to 10, and is preferably 6 or less on average.

The epoxy resin represented by the general formula (IX), which is illustrated below, may be a product (trade name: ESN-375) manufactured by Nippon Steel Chemical Co., Ltd. as a commercially available product. The epoxy resin represented by the general formula (X), which is illustrated below, may be a product (trade name: ESN-175) manufactured by Nippon Steel Chemical Co., Ltd. as a commercially available product.

The blend amount of the epoxidized naphthol/aralkyl resin is preferably 20% or more by mass of the total of the epoxy resin, more preferably 30% or more by mass thereof, even more preferably 50% or more by mass thereof in order to exhibit the performance of the resin.

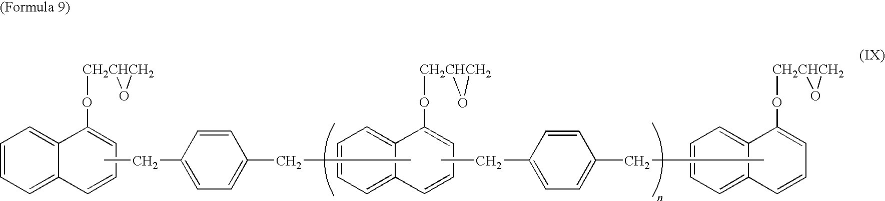

wherein n represent 0 or an integer of 1 to 10.

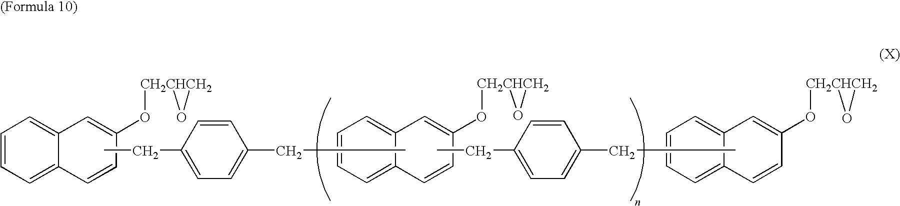

wherein n represent 0 or an integer of 1 to 10.

The biphenyl type epoxy resin, the bisphenol F type epoxy resin, the thiodiphenol type epoxy resin, the epoxidized phenol/aralkyl resin, and the epoxidized naphthol/aralkyl resin may be used alone or in combination of two or more thereof. When two or more thereof are used in combination, the blend amount thereof is preferably 20% or more by mass of the total of the epoxy resin, more preferably 30% or more by mass thereof, even more preferably 50% or more by mass thereof in order to exhibit the performance of the combination.

The curing agent (B) used in the invention is a curing agent which is ordinarily used in epoxy resin molding materials for sealing, and is not particularly limited. Examples thereof include Novolak type phenol resins each obtained by condensing or cocondensing a phenol, such as phenol, cresol, xylenol, resorcin, catechol, bisphenol A, bisphenol F, thiodiphenol, phenylphenol or aminophenol, and/or a naphthol, such as α-naphthol, β-naphthol or dihydroxynaphthalene, with a compound having an aldehyde group, such as formaldehyde, acetaldehyde, propionaldehyde, benzaldehyde or salicylaldehyde, in the presence of an acidic catalyst;

aralkyl phenol resins each synthesized from a phenol and/or a naphthol, and dimethoxy-p-xylene or bis(methoxymethyl)biphenol, examples of the resins including phenol/aralkyl resin and naphthol/aralkyl resin;

p-xylylene and/or m-xylylene-modified phenol resins;

substituted or unsubstituted melamine-modified phenol resins;

terpene-modified phenol resins;

dicyclopentadiene-modified phenol resins;

cyclopentadiene-modified phenol resins; and

polycyclic aromatic ring modified phenol resins. These may be used alone or in combination of two or more thereof. The molding material in particular preferably contains one or more species of phenol/aralkyl resin and naphthol/aralkyl resin from the viewpoint of flame retardancy.

Phenol/aralkyl resin is, for example, a resin represented by the following general formula (I):

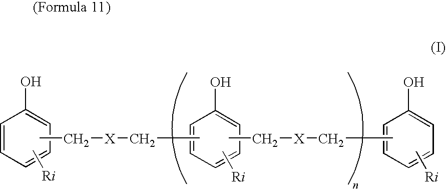

wherein Rs are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

Rs in the general formula (I) are each, for example, a linear alkyl group, such as a methyl, ethyl, propyl, isopropyl, n-butyl, sec-butyl, tert-butyl, pentyl, hexyl, octyl, decyl or dodecyl group, a cyclic alkyl group and a cyclic alkenyl group such as a cyclopentyl, cyclohexyl, cycloheptyl, cyclopentenyl or cyclohexenyl group, an aryl-group-substituted alkyl group such as a benzyl or phenethyl group, an alkoxy-group-substituted alkyl group such as a methoxy-group-substituted alkyl group, ethoxy-group-substituted alkyl group or butoxy-group-substituted alkyl group, an amino-group-substituted alkyl group such as an aminoalkyl, dimethylaminoalkyl or diethylaminoalkyl group, a hydroxyl-group-substituted alkyl group, an unsubstituted aryl group such as a phenyl, naphthyl or biphenyl group, an alkyl-group-substituted aryl group such as a tolyl, dimethylphenyl, ethylphenyl, butylphenyl, tert-butylphenyl or dimethylnaphthyl group, an alkoxy-group-substituted aryl group such as a methoxyphenyl, ethoxyphenyl, butoxyphenyl, tert-butoxyphenyl or methoxynaphthyl group, an amino-group-substituted aryl group such as an aminoaryl, dimethylaminoaryl or diethylaminoaryl group, or a hydroxyl-group-substituted aryl group. In particular, Rs are each preferably a hydrogen atom or a methyl group.

X(s) (each) represent(s) an aromatic-ring-containing bivalent organic group, and examples thereof include arylene groups, such as phenylene, biphenylene and naphthylene groups, alkyl-group-substituted arylene groups, such as a tolylene group, alkoxy-group-substituted arylene groups, bivalent groups each obtained from an aralkyl group, such as benzyl and phenethyl groups, aralkyl-group-substituted arylene groups, and bivalent groups each containing an arylene group, such as a xylylene group. X(s) is/are (each) in particular preferably a substituted or unsubstituted phenylene group from the viewpoint of compatibility between flame retardancy, fluidity and curability; thus, the resin is, for example, a phenol/aralkyl resin represented by a general formula (XI) illustrated below. From the viewpoint of compatibility between flame retardancy and reflow resistance, a substituted or unsubstituted biphenylene group is preferred; thus, the resin is, for example, a biphenylene-skeleton-containing phenol/aralkyl resin represented by a general formula (XII) illustrated below.

The symbol n represents 0 or an integer of 1 to 10, and is preferably 6 or less on average.

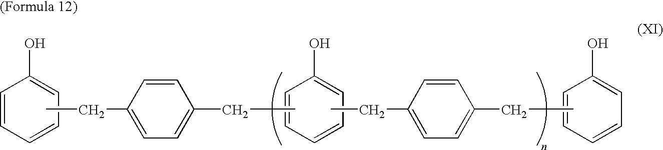

wherein n is 0 or an integer of 1 to 10.

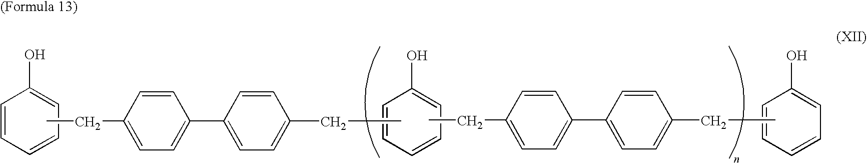

wherein n is 0 or an integer of 1 to 10.

The phenol/aralkyl resin represented by the general formula (XI) may be a product (tradename: XLC) manufactured by Mitsui Chemicals, Inc. as a commercially available product. The phenol/aralkyl resin represented by the general formula (XII) may be a product (trade name: MEH-7851) manufactured by Meiwa Plastic Industries, Ltd. as a commercially available product. The blend amount of the phenol/aralkyl resin is preferably 20% or more by mass of the total of the curing agent, more preferably 30% or more by mass thereof, even more preferably 50% or more by mass thereof in order to exhibit the performance of the resin.

Naphthol/aralkyl resin is, for example, a resin represented by the following general formula (II):

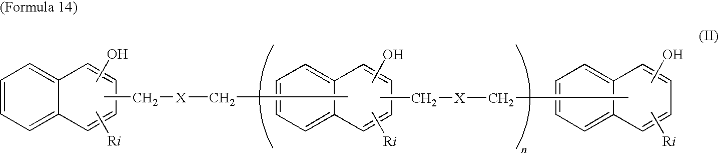

wherein Rs are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

Rs in the general formula (II) are each, for example, a linear alkyl group, such as a methyl, ethyl, propyl, isopropyl, n-butyl, sec-butyl, tert-butyl, pentyl, hexyl, octyl, decyl or dodecyl group, a cyclic alkyl group and a cyclic alkenyl group such as a cyclopentyl, cyclohexyl, cycloheptyl, cyclopentenyl or cyclohexenyl group, an aryl-group-substituted alkyl group such as a benzyl or phenethyl group, an alkoxy-group-substituted alkyl group such as a methoxy-group-substituted alkyl group, ethoxy-group-substituted alkyl group or butoxy-group-substituted alkyl group, an amino-group-substituted alkyl group such as an aminoalkyl, dimethylaminoalkyl or diethylaminoalkyl group, a hydroxyl-group-substituted alkyl group, an unsubstituted aryl group such as a phenyl, naphthyl or biphenyl group, an alkyl-group-substituted aryl group such as a tolyl, dimethylphenyl, ethylphenyl, butylphenyl, tert-butylphenyl or dimethylnaphthyl group, an alkoxy-group-substituted aryl group such as a methoxyphenyl, ethoxyphenyl, butoxyphenyl, tert-butoxyphenyl or methoxynaphthyl group, an amino-group-substituted aryl group such as an aminoaryl, dimethylaminoaryl or diethylaminoaryl group, or a hydroxyl-group-substituted aryl group. Particularly preferred is a hydrogen atom or a methyl group.

X(s) (each) represent(s) an aromatic-ring-containing bivalent organic group, and examples thereof include arylene groups, such as phenylene, biphenylene and naphthylene groups, alkyl-group-substituted arylene groups, such as a tolylene group, alkoxy-group-substituted arylene groups, bivalent groups each obtained from an aralkyl group, such as benzyl and phenethyl groups, aralkyl-group-substituted arylene groups, and bivalent groups each containing an arylene group, such as a xylylene group. Out of these groups, X(s) is/are (each) preferably a substituted or unsubstituted phenylene group or biphenylene from the viewpoint of compatibility between storage stability and flame retardancy, more preferably a phenylene group; thus, examples of the resin are naphthol/aralkyl resins represented by general formulae (XIII) and (XIV) illustrated below.

The symbol n represents 0 or an integer of 1 to 10, and is preferably 6 or less on average.

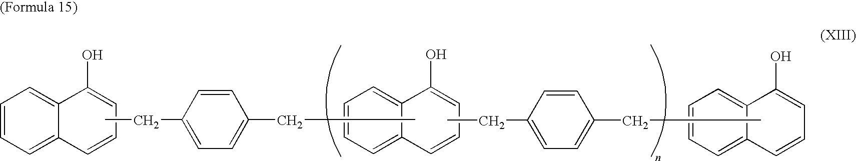

wherein n is 0 or an integer of 1 to 10.

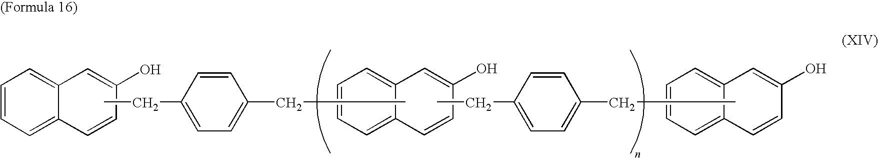

wherein n is 0 or an integer of 1 to 10.

The naphthol/aralkyl resin represented by the general formula (XIII) may be a product (trade name: SN-475) manufactured by Nippon Steel Chemical Co., Ltd. as a commercially available product. The naphthol/aralkyl resin represented by the general formula (XIV) may be a product (trade name: SN-170) manufactured by Nippon Steel Chemical Co., Ltd. as a commercially available product. The blend amount of the naphthol/aralkyl resin is preferably 20% or more by mass of the total of the curing agent (B) in order to exhibit the performance of the resin, more preferably 30% or more by mass thereof, even more preferably 50% or more by mass thereof.

It is preferred that the phenol/aralkyl resin represented by the general formula (I) and the naphthol/aralkyl resin represented by the general formula (II) are each an acenaphthylene-modified curing agent wherein a part or the whole of the resin is preliminarily mixed with acenaphthylene from the viewpoint of flame retardancy. Acenaphthylene can be obtained by dehydrogenating acenaphthene; however, a commercially available product thereof may be used. It is allowable to use, instead of acenaphthylene, a polymer made from acenaphthylene, or a copolymer made from acenaphthylene and a different aromatic olefin (hereinafter, the two polymers may be collectively referred to as an acenaphthylene-containing aromatic olefin polymer).

Examples of the method for yielding the acenaphthylene-containing aromatic olefin polymer include radical polymerization, cationic polymerization, and anionic polymerization. In the polymerization, a catalyst known in the prior art can be used; however, the polymerization can be conducted only by heat without using any catalyst. At this time, the polymerizing temperature is preferably from 80 to 160° C., more preferably from 90 to 150° C. The softening point of the resultant acenaphthylene-containing aromatic olefin polymer is preferably from 60 to 150° C., more preferably from 70 to 130° C. If the softening point is lower than 60° C., the moldability tends to lower by an ooze thereof when the molding material is molded. If the softening point is higher than 150° C., the compatibility with the resin tends to decline. Examples of the different aromatic olefin, which is copolymerized with acenaphthylene, include styrene, α-methylstyrene, indene, benzothiophene, benzofurane, vinylnaphthalene, vinylbiphenyl, and alkyl-substituted products thereof.

Besides the aromatic olefin, an aliphatic olefin may be used together as long as the advantageous effects of the invention are not damaged. Examples of the aliphatic olefin include (meth)acrylic acid and esters thereof; and maleic anhydride, itaconic anhydride and fumaric acid, and esters thereof. The use amount of the aliphatic olefin is preferably 20% or less by mass of the total of polymerizable monomers, more preferably 9% or less by mass thereof.

The method for mixing a part or the whole of the curing agent (s) represented by the general formula (e) (I) and/or (II) preliminarily with acenaphthylene is a method of pulverizing each of the curing agent(s) and acenaphthylene finely, and mixing the resultants, which are in a solid state, as they are by means of a mixer or the like; a method of dissolving the two (or three) components evenly into a solvent wherein the components can be dissolved, and then removing the solvent; a method of melt-mixing the two (or three) components at a temperature not lower than the softening point(s) of the curing agent(s) and/or acenaphthylene; or some other method. Of the methods, preferred is the melt-mixing method, in which a homogeneous mixture can be obtained and the amount of incorporated impurities is small. By each of the above-mentioned methods, a preliminary mixture (acenaphthylene-modified curing agent) is produced. The temperature at the time of the melt-mixing is not limited as long as the temperature is a temperature not lower than the softening point(s) of the curing agent(s) and/or acenaphthylene. The temperature is preferably from 100 to 250° C., more preferably from 120 to 200° C. The mixing time for the melt-mixing is not limited as long as the two (or the three) are evenly mixed therein. The time is preferably from 1 to 20 hours, more preferably from 2 to 15 hours. When the curing agent(s) is/are preliminarily mixed with acenaphthylene, acenaphthylene may be polymerized or may be caused to react with the curing agent(s) during the mixing. The preliminary mixing of the curing agent(s) with acenaphthylene and/or the acenaphthylene-containing aromatic olefin polymer can also be conducted in the same manner.

In the epoxy resin molding material of the invention for sealing, it is preferred that the curing agent(s) contain(s) therein the preliminary mixture (acenaphthylene-modified curing agent) in an amount of 50% or more by mass to improve the flame retardancy. The amount of the acetophenone and/or the acenaphthylene-containing aromatic olefin polymer contained in the acenaphthylene-modified curing agent is preferably from 5 to 40% by mass, more preferably from 8 to 25% by mass. If the amount is less than 5% by mass, the effect of improving the flame retardancy tends to decline. If the amount is more than 40% by mass, the moldability tends to decline. The content by percentage of the acenaphthylene and/or the acenaphthylene-containing aromatic olefin polymer contained in the epoxy resin molding material of the invention for sealing is preferably from 0.1 to 5% by mass from the viewpoint of flame retardancy and moldability, more preferably from 0.3 to 3% by mass. If the content by percentage is less than 0.1% by mass, the flame retardancy effect tends to decline. If the content by percentage is more than 5% by mass, the moldability tends to decline.

The ratio by equivalent between the epoxy resin (A) and the curing agent (B), that is, the ratio of the number of hydroxyl groups in the curing agent to the number of epoxy groups in the epoxy resin (the number of hydroxyl groups in the curing agent/the number of epoxy groups in the epoxy resin) is not particularly limited. The ratio is set preferably into the range of 0.5 to 2, more preferably into the range of 0.6 to 1.3 to control the unreacted amount of each of the components into a small amount. The ratio is set even more preferably into the range of 0.8 to 1.2 to obtain the epoxy resin molding material for sealing which is excellent in moldability.

When the ratio by equivalent between the epoxy resin and the curing agent is set, the ratio by equivalent is preferably set about the total of the colorant resin mixture in the invention, and the epoxy resin and/or the curing agent in the epoxy resin molding material for sealing other than the colorant resin mixture.

The resin molding material of the invention contains a colorant resin mixture wherein (C1) a resin is beforehand mixed with (D) a colorant having an electric resistivity of 1×10⁵Ω·cm or more (the mixture may be referred to as the colorant resin mixture (C) hereinafter).

The resin molding material of the invention further contains the colorant (D) having an electric resistivity of 1×10⁵Ω·cm or more alone, that is, in a state that it is not mixed with the resin (C1), whereby the colorant (D) may be used together with the colorant resin mixture (C).

When the molding material contains the colorant (D) having an electric resistivity of 1×10⁵Ω·cm or more, which may be referred to as the colorant (D), alone, the composition thereof may be equal to or different from the composition of the colorant (D) used in the colorant resin mixture (C).

The colorant (D) used in the invention is not particularly limited as long as the colorant has an electric resistivity of 1×10⁵Ω·cm or more. The resistivity is preferably 1×10⁶Ω·cm or more, more preferably 1×10⁷Ω·cm or more to prevent the generation of a failure based on a short circuit in an electronic component device equipped with an element sealed with the epoxy resin molding material of the invention for sealing. The electric resistivity can be obtained in accordance with JIS K1469 “Method for Measuring Electric Resistivity of Acetylene Black”. Examples of the colorant (D) include pitch, phthalocyanine dyes or pigments, aniline black, perylene black, black iron oxide, and black titanium oxide. Pitch or black titanium oxide is more preferred from the viewpoint of colorability and laser markability. From the viewpoint of colorability and a short circuit failure, pitch is preferred. The colorants may be used alone or in combination of two or more thereof.

Pitch, which is used in the invention, is a generic term of residual substances when coal tar, or a high-boiling-point byproduct in the petroleum industry, a typical example of the byproduct being asphalt, is subjected to dry distillation at a temperature of 360° C. or higher.

From the viewpoint of chemical composition, pitch is a meltable mixture composed of compounds each having, as a main structural element thereof, an aromatic structure, and is in a solid state at ambient temperature. Species of pitch are classified, in accordance with kinds of the starting material thereof, into coal based pitch, petroleum based pitch, naphthalene pitch, and acetylene pitch. Furthermore, in accordance with the degree of the treating temperature thereof and the treating time thereof, pitch is classified into optically isotropic pitch, mesophase (intermediate phase) pitch, and liquid crystal pitch. In mesophase pitch, carbonaceous microspheres, which may be referred to as mesophase microspheres, are formed. The mesophase microspheres can be separated as a soluble matter when mesophase pitch is dissolved into quinoline or the like.

As the pitch, any one of the above-mentioned pitches may be used. From the viewpoint of dispersibility in the epoxy resin molding material for sealing and colorability, pitch pulverized into fine particles is preferred, and mesophase microspheres are more preferred. Mesophase microspheres separated from coal based mesophase pitch are even more preferred. Such mesophase microspheres may be a product (trade name: MCMB GREEN PRODUCT) manufactured by Osaka Gas Chemicals Co., Ltd. as a commercially available product.

The carbon content by percentage in pitch used in the invention is preferably from 88 to 96% by mass, more preferably from 92 to 94% by mass. If the carbon content by percentage is less than 88% by mass, the colorability tends to lower. If it is more than 96% by mass, the electric resistivity tends to be small.

Black titanium oxide used in the invention is obtained by reducing titanium oxide (TiO₂), which is known as a white pigment, at high temperature so as to remove oxygen in titanium oxide partially. Black titanium oxide, as described herein, may be a product (trade name: TITANIUM BLACK) manufactured by Jemco Inc. as a commercially available product.

The resin (C1) used in the preparation of the colorant resin mixture (C) in the invention is not particularly limited as long as the invention is attained. Examples thereof include epoxy resin, curing agents, urea resin, melamine resin, silicone resin, acrylic resin, polyethylene, polypropylene, and polystyrene. Epoxy resin, curing agents and others are preferred from the viewpoint of fluidity and even dispersibility of the colorant. At least one of epoxy resin and a curing agent is preferred. The epoxy resin and the curing agent may be equal in composition to or different in composition from the epoxy resin (A) and the curing agent (B), respectively, and are preferably equal in composition thereto.

The colorant resin mixture (C) used in the invention can be prepared by any method that makes it possible to mix the colorant (D) and resin (C1) for uniform dispersion. An example thereof is a method in which: the starting materials having predetermined blend amounts are melt-mixed with each other in a flask or the same are melt-kneaded by means of a mixing roll, an extruder or the like; and when the mixture is in a solid form, the mixture is pulverized and then used, or when the mixture is in a liquid form at room temperature, the mixture is filled into a freely-selected container and then used. The use of a mixing roll or an extruder is preferred from the viewpoint of uniform dispersion of the colorant.

From the viewpoint of colorability, electric characteristics, moldability and laser markability, it is preferred to adjust the shape or the particle diameter of the colorant (D) by means of a pulverizer or some other machine, and subsequently prepare the colorant resin mixture (C). The shape is preferably spherical from the viewpoint of moldability, and the particle diameter is preferably small from the viewpoint of colorability, electric characteristics, and laser markability. The machine used for the adjustment of the colorant is not particularly limited as long as this machine is a machine used to adjust shape or particle diameter. Examples thereof include roller mills such as a ring roller mill, a roller race mill and a ball race mill; high-speed rotary mills such as an atomizer, a cage mill, and a screen mill; ball mills such as a tumbling ball mill, a vibrating ball mill, and a planetary mill; medium-stirring mills such as a tower type pulverizer, a stirring tank type mill, and a circulating tank type mill; air current type pulverizers such as a Jetmizer, and a counter jet mill; a compaction shearing mill; and a colloid mill. Before and/or after the machine is used, a classifier may be used. The classifier may be built in the machine.

When a process using water or an organic solvent, which is generally called a wet process, is used in the adjustment of the shape or particle diameter of the colorant (D), the colorant after the adjustment is obtained as a mixture of the colorant and the solvent. It is therefore preferred to remove the solvent when the colorant resin mixture used in the invention is prepared. From the viewpoint of moldability and reflowability, it is preferred that the solvent is sufficiently removed at latest up to the incorporation of the colorant into the resin molding material. The method for removing the solvent is not particularly limited, and is preferably performed under a heating condition and/or under a reduced pressure condition.

The blend amount of the colorant in the preparation of the colorant resin mixture (C) in the invention is not particularly limited as long as the advantageous effects of the invention are attained. The amount is preferably from 2 to 70 parts by mass, more preferably from 2 to 60 parts by mass, even more preferably from 3 to 30 parts by mass for 100 parts by mass of the resin (C1) in the colorant resin mixture.

From the viewpoint of colorability and a failure based on a short circuit, the colorant resin mixture preferably contains pitch therein.

The amount of pitch in the colorant resin mixture (C) is preferably 30% or more by mass, more preferably 45% or more by mass, in particular preferably 60% or more by mass of the total of the colorant other than pitch in the colorant resin mixture (C) and pitch in the colorant resin mixture (C), that is, the total of the colorants in the colorant resin mixture (C). A preferred ratio between the amount of the colorant (D) which is alone incorporated and that of pitch contained therein is the same as described above.

The amount of the colorant in the colorant resin mixture (C) is preferably 50% or more by mass of the total of the colorant (D) not mixed with the resin and the colorant in the colorant resin mixture (C), that is, the total of the colorants in the resin molding material of the invention.

In the invention, a dispersing agent may be used to disperse the colorant(s) uniformly. The dispersing agent is not particularly limited as long as the advantageous effects of the invention are attained. Examples thereof include silane compounds such as alkoxysilane, chlorosilane and polysiloxane; carboxylic acids such as succinic acid, stearic acid and oleic acid; amino acids such as alanine and glycine; thiol compounds such as thioalcohol and thioamino acid; titanium based compounds such as titanate based coupling agents; cationic surfactants, which have a cation, such as quaternary ammonium salts; anionic surfactants, which have an anion, such as carboxylic acid salts and phosphoric acid salts; ampholytic surfactants, which have a cation and an anion; nonionic surfactants, which have no ionic groups, such as ethylene glycol and derivatives of sugar; and rosin. These may be used alone or in combination of two or more thereof. These dispersing agents may be used in the preparation of the colorant resin mixture in the invention, or may be used in the production of the epoxy resin molding material for sealing.

The blend amount of the colorant (D) in the epoxy resin molding material for sealing is not particularly limited as long as the epoxy resin molding material for sealing can be colored into black, and is preferably from 2 to 20 parts by mass, more preferably from 2 to 15 parts by mass, even more preferably from 3 to 10 parts by mass for 100 parts by mass of the epoxy resin.

In this case, the epoxy resin amount is the total amount of the epoxy resin(s) in the resin molding material, and includes the amount of the epoxy resin in the resin (C1).

From the viewpoint of colorability and a failure based on a short circuit, the colorant (D) preferably contains pitch. The added amount of the pitch is not particularly limited as long as the advantageous effects of the invention can be obtained. The amount is preferably 30% or more by mass, more preferably 45% or more by mass, even more preferably 60% by mass of the total of pitch and the colorant other than pitch, that is, the total of the colorant(s) (D).

The epoxy resin molding material of the invention for sealing preferably contains a curing promoter. The used curing promoter is not particularly limited as long as the promoter is a promoter used ordinarily in epoxy resin molding materials for sealing. Examples thereof include cycloamidine compounds such as 1,8-diazabicyclo[5.4.0]undecene-7, 1,5-diazabicyclo[4.3.0]nonane-5, and 5,6-dibutylamino-1,8-diazabicyclo[5.4.0]undecene-7, derivatives of the compounds, and compounds which have intermolecular polarity and are obtained by adding, to the compounds, a compound having a π bond such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, or phenyl-1,4-benzoquinone, diazophenylmethane, or phenol resin;

tertiary amines and derivatives thereof such as benzyldimethylamine, triethanolamine, dimethylaminoethanol and tris(dimethylaminomethyl)phenol;

imidazoles and derivatives thereof such as 2-methylimidazole, 2-phenylimidazole, 2-phenyl-4-methylimidazole and 2-heptadecylimidazole;

organic phosphines, such as trialkylphosphines such as tributylphosphine, dialkylarylphosphines such as dimethylphenylphosphine, alkyldiarylphosphines such as methyldiphenylphosphine, tris(alkylphenyl)phosphines such as triphenylphosphine and tris(4-methylphenyl)phosphine, tris(alkoxyphenyl)phosphines, tris(alkyl/alkoxyphenyl)phosphines, tris(dialkylphenyl)phosphines, tris(trialkylphenyl)phosphines, tris(tetraalkylphenyl)phosphines, tris(dialkoxyphenyl)phosphines, tris(trialkoxyphenyl)phosphines, tris(tetraalkoxyphenyl)phosphines, diphenylphosphine, and diphenyl(p-tolyl)phosphine, derivatives thereof, and phosphorus compounds which have intermolecular polarity and are obtained by adding, to the compounds, a compound having a π bond such as a quinone compound, maleic anhydride, diazophenylmethane or phenol resin;

tetraphenyl borates such as tetraphenylphosphonium tetraphenyl borate, triphenylphosphine tetraphenyl borate, 2-ethyl-4-methylimidazole tetraphenyl borate, and N-methylmorpholine tetraphenyl borate, and derivatives thereof, and complexes each made from an organic phosphine and an organic boron. These may be used alone or in combination of two or more thereof.

Particularly preferred is an adduct of a tertiary phosphine compound and a quinone compound from the viewpoint of fluidity and curability. More preferred are an adduct of triphenylphosphine and 1,4-benzoquinone, and an adduct of tributylphosphine and 1,4-benzoquinone.

The blend amount of the curing promoter is not particularly limited as long the effect of promoting the curing is attained. The amount is preferably from 0.2 to 10 parts by mass for 100 parts by mass of the total of the epoxy resin and the curing agent. If the amount is less than 0.2 part by mass, the curability tends to be insufficient. If the amount is more than 10 parts by mass, the fluidity tends to decline. When the epoxy resin and/or the curing agent is/are contained in the resin (C1) in the colorant resin mixture (C), the resin and/or the agent in the resin (C1) is/are also added to the above-mentioned total.

The epoxy resin molding material of the invention for sealing preferably contains an inorganic filler. The used inorganic filler is a substance incorporated into the molding material to decrease hygroscopicity and the linear expansion coefficient, improve the thermal conductivity and improve the strength, and is not particularly limited as long as the filler is an inorganic filler used ordinarily in epoxy resin molding materials for sealing. Examples thereof include fused silica, crystalline silica, alumina, zircon, calcium silicate, calcium carbonate, potassium titanate, silicon carbide, silicon nitride, aluminum nitride, boron nitride, beryllia, zirconia, zircon, forsterite, steatite, spinel, mullite and titania powders; beads obtained by making these powders into spheres; and glass fiber. These may be used alone or in combination of two or more thereof. From the viewpoint of a decrease in the linear expansion coefficient, fused silica is preferred, and from the viewpoint of a high thermal conductivity, alumina is preferred. The shape of the filler is preferably spherical from the viewpoint of the fluidity and mold abrasion when the epoxy resin molding material is molded.

The blend amount of the inorganic filler is preferably from 70 to 95 parts by mass for 100 parts by weight of the epoxy resin molding material for sealing from the viewpoint of improving or promoting the flame retardancy, the moldability, a decrease in the hygroscopicity and the linear expansion coefficient, and the strength. From the viewpoint of a decrease in the hygroscopicity and the linear expansion coefficient, the amount is more preferably from 85 to 95 parts by mass. If the amount is less than 70 parts by mass, the flame retardancy effect and the reflow resistance effect tend to deteriorate. If the amount is more than 95 parts by mass, the fluidity tends to be insufficient.

It is preferred that an ion trapping agent is further incorporated into the epoxy resin molding material of the invention for sealing as the need arises in order to improve the moisture resistance and high-temperature storage of semiconductor elements such as ICs. The ion trapping agent is not particularly limited, and may be an agent known in the prior art. Examples thereof include hydrotalcite, and hydrated oxides of one or more elements selected from magnesium, aluminum, titanium, zirconium and bismuth. These may be used alone or in combination of two or more thereof. Particularly preferred is a hydrotalcite represented by the following composition formula (XV):

### (Formula 17)

Mg₁₋ₓAlₓ(OH)₂(CO₃)_{x/2}·mH₂O (XV)

wherein 0≦x≦0.5, and m is a positive number.

The blend amount of the ion trapping agent is not particularly limited as long as the amount is an amount sufficient for trapping an anion such as a halogen ion. The amount is preferably from 0.1 to 30 parts by mass, more preferably from 0.5 to 10 parts by mass, even more preferably from 1 to 5 parts by mass for 100 parts by mass of the epoxy resin from the viewpoint of fluidity and bending strength.

In order to make the adhesiveness between the resin component(s) and the inorganic filler high, it is preferred to add, to the epoxy resin molding material of the invention for sealing as the need arises, a known coupling agent, examples of which include various silane compounds such as epoxy silanes, mercaptosilanes, aminosilanes, alkylsilanes, ureidosilanes and vinylsilanes, titanium-based compounds, aluminum chelates, and aluminum/zirconium based compounds.

Examples thereof include silane coupling agents such as vinyltrichlorosilane, vinyltriethoxysilane, vinyltris(β-methoxyethoxy)silane, γ-methacryloxypropyltrimethoxysilane, γ-methacryloxypropyltriethoxysilane, γ-acryloxypropyltrimethoxysilane, β-(3,4-epoxycyclohexyl)ethyltrimethoxysilane, γ-glycycloxypropyltrimethoxysilane, γ-glycycloxypropylmethyldimethoxysilane, vinyltriacetoxysilane, γ-mercaptopropyltrimethoxysilane, γ-aminopropyltriethoxysilane, γ-anilinopropyltrimethoxysilane, γ-anilinopropylmethyldimethoxysilane, γ-[bis(β-hydroxyethyl)]aminopropyltriethoxysilane, N-β-(aminoethyl)-γ-aminopropyltrimethoxysilane, γ-(β-aminoethyl)aminopropyldimethoxymethylsilane, N-(trimethoxysilylpropyl)ethylenediamine, N-(dimethoxymethylsilylisopropyl)ethylenediamine, methyltrimethoxysilane, dimethyldimethoxysilane, methyltriethoxysilane, N-β-(N-vinylbenzylaminoethyl)-γ-aminopropyltrimethoxysilane, γ-chloropropyltrimethoxysilane, hexamethyldisilane, vinyltrimethoxysilane, and γ-mercaptopropylmethyldimethoxysilane; and titanate coupling agents such as isopropyltriisostearoyl titanate, isopropyltris(dioctylpyrophosphate)titanate, isopropyltri(N-aminoethyl-aminoethyl)titanate, tetraoctylbis(ditridecylphosphate)titanate, tetra(2,2-diallyloxymethyl-1-butyl)bis(ditridecyl)phosphate titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridecylbenzenesulfonyl titanate, isopropylisostearoyldiacryl titanate, isopropyltri(dioctylphosphate)titanate, isopropyltricumylphenyl titanate, and tetraisopropylbis(dioctylphosphite)titanate. These may be used alone or in combination of two or more thereof.

The blend amount of the coupling agent is preferably from 0.05 to 5 parts by mass, more preferably from 0.1 to 2.5 parts by mass for 100 parts by mass of the inorganic filler. If the amount is less than 0.05 part by mass, the effect of improving the adhesiveness to various package constituting members tends to fall. If the amount is more than 5 parts by mass, molding defects such as voids tend to be easily generated.

It is preferred that a flame retardant is incorporated into the epoxy resin molding material of the invention for sealing as the need arises. The flame retardant may be brominated epoxy resin or antimony trioxide, which is known in the prior art, and is preferably a halogen-free or antimony-free flame retardant known in the prior art.

Examples thereof include phosphorus compounds such as red phosphorus, red phosphorus coated with a thermosetting resin such as phenol resin, or the like, phosphates, and oxidized triphenylphosphine; compounds having a triazinering, such as melamine, melamine derivatives, and melamine-modified phenol resin; nitrogen-containing compounds such as cyanuric acid derivatives, and isocyanuric acid derivatives; phosphorus- and nitrogen-containing compounds such as cyclophosphazene; metal complex compounds such as dicyclopentadienyliron; zinc compounds such as zinc oxide, zinc stannate, zinc borate, and zinc molybdate; metal oxides such as iron oxide, and molybdenum oxide; metal hydroxides such as aluminum hydroxide, and magnesium hydroxide; composite metal hydroxides represented by a composition formula (XVI) illustrated below. These may be used alone or in combination of two or more thereof.

### (Formula 18)

p(M¹ₐO_{b})·q(M²_{c}O_{d})·r(M³ₑO_{f})·mH₂O (XVI)

wherein M¹, M² and M³ represent metal elements different from each other, and a, b, C, d, p, q, and m each represent a positive number, and r represents 0 or a positive number.

In the composition formula (XVI), M¹ and M² and M³ are not particularly limited as long as they are metal elements different from each other. From the viewpoint of flame retardancy, it is preferred that M¹ is selected from metal elements in the third period, alkaline earth metal elements in the group IIA, and metal elements in the groups IVB, IIB, VIII, IB, IIIA and IVA; and M² is selected from transition metal elements in the groups IIIB to IIB. It is more preferred that M¹ is selected from magnesium, calcium, aluminum, tin, titanium, iron, cobalt, nickel, copper and zinc; and M² is selected from iron, cobalt, nickel, copper and zinc. From the viewpoint of fluidity, preferred is a substance wherein M¹ is magnesium, M² is zinc or nickel, and r=0. The ratio by mole between p, q and r is not particularly limited. It is preferred that r is zero and p/q is from 1/99 to 1/1. The classification of the metal elements is made on the basis of the long form of the periodic table, wherein typical elements and transition elements are grouped into subgroup A and subgroup B, respectively (source: “Dictionary of Chemistry 4” (“Kagaku Dai-Jiten 4”), 26^{th} impression of reduced-size edition on Oct. 15, 1981, published by Kyoritsu Shuppan Co., Ltd.).

The above-mentioned flame retardants may be used alone or in combination of two or more thereof.

It is preferred that as long as the advantageous effects of the invention are not damaged, other additives are incorporated into the epoxy resin molding material of the invention for sealing as the need arises, examples of the additives including higher aliphatic acids, higher aliphatic acid metal salts, ester-based waxes, amide-based waxes, polyolefin-based waxes, polyethylene, polyethyleneoxide, and other releasing agents; silicone oil, silicone resin, liquid rubber, rubber powder, thermoplastic resins, and other stress relaxing agents; and carbon black and other conventional colorants. When two or more colorants different from each other in electric resistivity are together used as the colorants (D), a conventional colorant may be together used if the electric resistivity of the mixture where these are mixed with each other is 1×10⁵Ω·cm or more.

The epoxy resin molding material of the invention for sealing can be prepared by any method as long as the individual starting materials can be evenly dispersed and mixed. An ordinary example of the method is a method of mixing the starting materials having predetermined amounts sufficiently with each other by means of a mixer or the like, melting/kneading the mixture by means of a mixing roll, an extruder or the like, cooling the mixture, and pulverizing the resultant. The resultant may be made into the form of tablets having a size and a mass corresponding to molding conditions. The tablets are convenient for use.

An example of an electronic component device equipped with an element sealed with the epoxy resin molding material for sealing, obtained according to the invention is an electronic component device wherein: active elements, such as a semiconductor chip, a transistor, a diode and a thyristor, passive elements such as a condenser, a resistor and a coil, and other elements are mounted on a supporting member such as a lead frame, a wired tape carrier, a wired board, a glass piece or a silicon wafer; and required portions are sealed with the epoxy resin molding material of the invention for sealing. Examples of the electronic component device include a DIP (dual inline package), a PLCC (plastic leaded chip carrier), a QFP (quad flat package), an SOP (small outline package), an SOJ (small outline J-lead package), a TSOP (thin small outline package), a TQFP (thin quad flat package), and other ordinary resin-sealed ICs, wherein semiconductor elements are fixed on a lead frame, terminal regions of the elements, such as bonding pads thereof, are connected to lead regions through wire bonding or bumps, and then the resultant is sealed by transfer molding or the like, using the epoxy resin molding material of the invention for sealing; a TCP (tape carrier package), wherein semiconductor chips connected to a tape carrier through bumps are sealed with the epoxy resin molding material of the invention for sealing; a COB (chip on board) module, wherein active elements, such as a semiconductor chip, a transistor, a diode and a thyristor, and/or passive elements, such as a condenser, a resistor and a coil, connected to wires formed on a wiring board or a glass piece by wire bonding, flip-chip bonding, solder or the like are sealed with the epoxy resin molding material of the invention for sealing; a hybrid IC; a multi chip module; a BGA (ball grid array), a CSP (chip size package) and an MCP (multi chip package), wherein semiconductor chips are mounted on an interposer substrate on which terminals for connection to a mother board are formed, the semiconductor chips are connected to wiring formed on the interposer substrate through bumps or wire bonding, and then the resultant is sealed, on a side thereof on which the semiconductor chips are mounted, with the epoxy resin molding material of the invention for sealing and other single face sealed packages. The epoxy resin molding material for sealing that is obtained by the invention does not contain any electroconductive material, which causes a failure based on a short circuit; thus, this material is particularly suitable for fine-pitch semiconductor devices and other fine-pitch electronic component devices, wherein the distances between inner leads, between pads, and between wires are small.

The method for sealing an element with the epoxy resin molding material of the invention for sealing is most popularly low-pressure transfer molding; injection molding, compression molding or the like may be used.

### EXAMPLES

The invention will be described by way of the following examples; however, the scope of the invention is not limited to these examples.

Components described below were used to produce colorant resin mixtures (C) wherein a resin (C1) was before hand mixed with a colorant (D) having an electric resistivity of 1×10⁵Ω·cm or more by methods described in Production Examples 1 to 7.

The following were used: mesophase microspheres having an average particle diameter of 3 μm, a carbon content by percentage of 92.5%, an electric resistivity of 1.7×10⁷Ω·cm (trade name: MCMB GREEN PRODUCT, manufactured by Osaka Gas Chemicals Co., Ltd.); and a black titanium oxide having an average particle diameter of 70 nm, and an electric resistivity of 4.1×10⁶ Ωcm (trade name: TITANIUM BLACK, manufactured by Jemco Inc.). The carbon content by percentage was obtained, using an organic element analyzer (EA-1108, manufactured by Carloerba). The electric resistivity was obtained in accordance with JISK1469 “Method for Measuring Electric Resistivity of Acetylene Black” in the following manner: 3 g of the sample was put into electrodes made of brass and having a sectional area of 4.9 cm² in a hollow, insulated, cylindrical container; when the sample was pressed at 4.9 MPa, the sample thickness (cm) was measured; next, the electrodes were connected to an ohmmeter (TR8601, manufactured by Advantest Corp.), and then the resistance value (Ω) was measured at a 100-V DC; and the electric resistivity (Ω·cm) was calculated from the following expression: the sectional area (4.9 cm²)×the resistance value (Ω)/the sample thickness (cm).

Epoxy resins used were: a biphenyl type epoxy resin having epoxy equivalents of 187 and a melting point of 109° C. (epoxy resin 1; trade name: EPIKOTE YX-4000, manufactured by Japan Epoxy Resins Co., Ltd.); and a bisphenol F type epoxy resin having epoxy equivalents of 188 and a melting point of 75° C. (epoxy resin 2; tradename: YSLV-80XY, manufactured by Nippon Steel Chemical Co., Ltd.).

Curing agents used were: a phenol/aralkyl resin having hydroxyl group equivalents of 176 and a softening point of 70° C. (curing agent 1; trade name: MIREX XLC, manufactured by Mitsui Chemicals, Inc.); and an acenaphthylene-containing β-naphthol/aralkyl resin having hydroxyl group equivalents of 209, and a softening point of 81° C. (curing agent 2; trade name: SN-179-AR10, manufactured by Nippon Steel Chemical Co., Ltd.).

### Production Example 1

### Production of a Colorant Resin Mixture A

A three-axis roll was used to knead 270 g of the epoxy resin 1 and 30 g of the mesophase microspheres by means of the three-axis roll under conditions that the kneading temperature was 100° C. and the number of operations for the kneading was 4, thereby producing a colorant resin mixture A.

### Production Example 2

### Production of a Colorant Resin Mixture B

A three-axis roll was used to knead 270 g of the epoxy resin 2 and 30 g of the mesophase microspheres under conditions that the kneading temperature was 70° C. and the number of operations for the kneading was 4, thereby producing a colorant resin mixture B.

### Production Example 3

### Production of a Colorant Resin Mixture C

A three-axis roll was used to knead 270 g of the curing agent 1 and 30 g of the mesophase microspheres under conditions that the kneading temperature was 80° C. and the number of operations for the kneading was 4, thereby producing a colorant resin mixture C.

### Production Example 4

### Production of a Colorant Resin Mixture D

A three-axis roll was used to knead 150 g of the curing agent 1 and 100 g of the mesophase microspheres under conditions that the kneading temperature was 80° C. and the number of operations for the kneading was 4, thereby producing a colorant resin mixture D.

### Production Example 5

### Production of a Colorant Resin Mixture E

A three-axis roll was used to knead 270 g of the curing agent 2 and 30 g of the mesophase microspheres under conditions that the kneading temperature was 90° C. and the number of operations for the kneading was 4, thereby producing a colorant resin mixture E.

### Production Example 6

### Production of a Colorant Resin Mixture F

A three-axis roll was used to knead 225 g of the curing agent 1, 15 g of the mesophase microspheres, and 10 g of the black titanium oxide under conditions that the kneading temperature was 80° C. and the number of operations for the kneading was 4, thereby producing a colorant resin mixture F.

### Production Example 7

### Production of a Colorant Resin Mixture G

Blended were 100 g of the mesophase microspheres and 900 g of 2-butanone, and a bead mill (trade name: SUPER APEX MILL UAM-015, manufactured by Kotobuki Industries Co., Ltd.) was used to yield a mesophase microsphere dispersed liquid under conditions that the particle diameter of zirconia beads was 0.2 mm, the peripheral speed was 10 m/s, and the liquid temperature was from 17 to 19° C., and the time for dispersion was 60 minutes. Next, 90 g of the curing agent 1 was mixed with 100 g of the mesophase microsphere dispersed liquid at 25° C. for 30 minutes, and 2-butanone was removed by heating under a reduced pressure (at 150° C. and 1.3 hPa). In this way, a colorant resin mixture G was produced.

### Examples 1 to 18, and Comparative Examples 1 to 12

Components described below were blended to account for individual parts by mass shown in Tables 1 to 5 described below, and the resultant blends were each kneaded with rolls at a kneading temperature of 80° C. for a kneading time of 10 minutes to produce epoxy resin molding materials, for sealing, of Examples 1 to 18 and Comparative Examples 1 to 12. In the tables, blanks each means that the corresponding component was not blended.

Colorant resin mixtures (C) used were the colorant resin mixtures A to G produced as described above. Separately, as a colorant (D) to be alone incorporated, the following were each used: the above-mentioned mesophase microspheres (electric resistivity: 1.7×10⁷Ω·cm); and the above-mentioned black titanium oxide (electric resistivity: 4.1×10⁶Ω·cm). For comparison, there was used carbon black having an average particle diameter of 22 nm, a carbon content by percentage of 97.4%, and an electric resistivity of 1.5×10⁻¹Ω·cm (tradename: MA-100, manufactured by Mitsubishi Chemical Corp.).

Epoxy resins (A) used were: the epoxy resin 1; the epoxy resin 2; a mixture of a phenol/aralkyl type epoxy resin and 4,4′-bis(2,3-epoxypropoxy)biphenyl (blend ratio by mass: 8/2) having epoxy equivalents of 241 and a softening point of 95° C. (epoxy resin 3; trade name: CER-3000L, manufactured by Nippon Kayaku Co., Ltd.); a β-naphthol/aralkyl type epoxy resin having epoxy equivalents of 265 and a softening point of 66° C. (epoxy resin 4; tradename: ESN-175S, manufactured by Nippon Steel Chemical Co., Ltd.); a thiodiphenol type sulfur-atom-containing epoxy resin having epoxy equivalents of 242 and a melting point of 110° C. (epoxy resin 5; trade name: YSLV-120TE, manufactured by Nippon Steel Chemical Co., Ltd.); and a brominated bisphenol A type epoxy resin having epoxy equivalents of 397 and a softening point of 69° C., a bromine content by percentage of 49% by mass (epoxy resin 6; trade name: EPOTOTOYDB-400, manufactured by Tohto Kasei Co., Ltd.).

Curing agents (B) used were: the curing agent 1; the curing agent 2; a phenol/aralkyl resin having hydroxyl group equivalents of 200 and a softening point of 80° C. (curing agent 3; trade name: MEH-7851, manufactured by Meiwa Plastic Industries, Ltd.); a phenol resin having hydroxyl group equivalents of 103 and a softening point of 86° C. (curing agent 4; trade name: MEH-7500, manufactured by Meiwa Plastic Industries, Ltd.); and a phenol resin having hydroxyl group equivalents of 156 and a softening point of 83° C. (curing agent 5; tradename: HE-510, manufactured by Sumikin Air Water Chemical Inc.).

Curing promoters used were: an addition reaction product made from triphenylphosphine and 1,4-benzoquinone (curing promoter 1); and an addition reaction product made from tributylphosphine and 1,4-benzoquinone (curing promoter 2).

An inorganic filler used was spherical fused silica having an average particle diameter of 17.5 μm, and a specific surface area of 3.8 m²/g, and a coupling agent used was γ-glycidoxypropyltrimethoxysilane (trade name: Z-6040, manufactured by Dow Corning Toray Co., Ltd.). Other additives used were carnauba wax (manufactured by Clariant), and antimony trioxide.

TABLE 1
(unit: parts by mass)

| | Example | | | | | |
|---|---|---|---|---|---|---|
| Item | 1 | 2 | 3 | 4 | 5 | 6 |
| colorant resin | 50 | | | | | |
| mixture A | | | | | | |
| colorant resin | | 18 | 50 | | 50 | 50 |
| mixture C | | | | | | |
| colorant resin | | | | 50 | | |
| mixture G | | | | | | |
| mesophase | | | | | | 3 |
| microspheres | | | | | | |
| black titanium | | | | | 3 | |
| oxide | | | | | | |
| Epoxy resin 1 | 55 | 100 | 100 | 100 | 100 | 100 |
| Curing agent 1 | 94 | 77.8 | 49 | 49 | 49 | 49 |
| Curing promoter 1 | 3 | 3 | 3 | 3 | 3 | 3 |
| carnauba wax | 1 | 1 | 1 | 1 | 1 | 1 |
| coupling agent | 10 | 10 | 10 | 10 | 10 | 10 |
| fused silica | 1826 | 1798 | 1826 | 1826 | 1852 | 1852 |

TABLE 2
(unit: parts by mass)

| | Example | | | | | |
|---|---|---|---|---|---|---|
| Item | 7 | 8 | 9 | 10 | 11 | 12 |
| colorant resin | | | | 50 | 50 | 50 |
| mixture B | | | | | | |
| colorant resin | 12.5 | | 45 | | | |
| mixture D | | | | | | |
| colorant resin | | 75 | | | | |
| mixture F | | | | | | |
| Epoxy resin 1 | 100 | 100 | 100 | | | |
| Epoxy resin 2 | | | | 55 | 55 | 55 |
| Curing agent 1 | 89 | 26.5 | 67 | | | |
| Curing agent 3 | | | | 106 | 43 | |
| Curing agent 4 | | | | | 33 | |
| Curing agent 5 | | | | | | 83 |
| Curing promoter 1 | 3 | 3 | 3 | | | |
| Curing promoter 2 | | | | 7 | 4.5 | 5 |
| carnauba wax | 1 | 1 | 1 | 1 | 1 | 1 |
| coupling agent | 10 | 10 | 10 | 10 | 10 | 10 |
| fused silica | 1826 | 1847 | 1937 | 2106 | 1799 | 1873 |

TABLE 3
(unit: parts by mass)

| | Example | | | | | |
|---|---|---|---|---|---|---|
| Item | 13 | 14 | 15 | 16 | 17 | 18 |
| colorant resin | 50 | | 50 | | 50 | 50 |
| mixture C | | | | | | |
| colorant resin | | 50 | | 50 | | |
| mixture E | | | | | | |
| Epoxy resin 1 | | | | | | 85 |
| Epoxy resin 3 | 100 | 100 | | | | |
| Epoxy resin 4 | | | 100 | 100 | | |
| Epoxy resin 5 | | | | | 100 | |
| Epoxy resin 6 | | | | | | 15 |
| Curing agent 1 | 28 | | 21 | | 28 | 42 |
| Curing agent 2 | | 42 | | 34 | | |
| Curing promoter 1 | 2.5 | 3 | 2.8 | 3 | 3 | 3 |
| carnauba wax | 1 | 1 | 1 | 1 | 1 | 1 |
| coupling agent | 10 | 10 | 10 | 10 | 10 | 10 |
| antimony trioxide | | | | | | 5 |
| fused silica | 1441 | 1547 | 1393 | 1488 | 1442 | 1584 |

TABLE 4
(unit: parts by mass)

| | Comparative Example | | | | | | |
|---|---|---|---|---|---|---|---|
| Item | 1 | 2 | 3 | 4 | 5 | 6 | 7 |
| Carbon black | 3.5 | 3.5 | 3.5 | 3.5 | 3.5 | 3.5 | 3.5 |
| Epoxy resin 1 | 100 | | | | | | |
| Epoxy resin 2 | | 100 | 100 | | | | |
| Epoxy resin 3 | | | | 100 | 100 | | |
| Epoxy resin 4 | | | | | | 100 | 100 |
| Curing agent 1 | 94 | | | 73 | | 66 | |
| Curing agent 2 | | | | | 87 | | 79 |
| Curing agent 3 | | 106 | 43 | | | | |
| Curing agent 4 | | | 33 | | | | |
| Curing romoter 1 | 3 | | | 2.5 | 3 | 2.8 | 3 |
| Curing promoter 2 | | 7 | 4.5 | | | | |
| carnauba wax | 1 | 1 | 1 | 1 | 1 | 1 | 1 |
| coupling agent | 10 | 10 | 10 | 10 | 10 | 10 | 10 |
| fused silica | 2024 | 2320 | 1979 | 1619 | 1740 | 1566 | 1673 |

TABLE 5
(unit: parts by mass)

| | Comparative Example | | | | |
|---|---|---|---|---|---|
| Item | 8 | 9 | 10 | 11 | 12 |
| mesophase | 5 | 5 | 5 | 5 | 5 |
| microspheres | | | | | |
| Epoxy resin 1 | 100 | | | | |
| Epoxy resin 2 | | 100 | 100 | | |
| Epoxy resin 3 | | | | 100 | |
| Epoxy resin 4 | | | | | 100 |
| Curing agent 1 | 94 | | | | |
| Curing agent 2 | | | | 87 | 79 |
| Curing agent 3 | | 106 | 43 | | |
| Curing agent 4 | | | 33 | | |
| Curing promoter 1 | 3 | | | 3 | 3 |
| Curing promoter 2 | | 7 | 4.5 | | |
| carnauba wax | 1 | 1 | 1 | 1 | 1 |
| coupling agent | 10 | 10 | 10 | 10 | 10 |
| fused silica | 1826 | 2106 | 1799 | 1547 | 1488 |

The produced epoxy resin molding materials for sealing of Examples and Comparative Examples were evaluated by individual tests described below. The results are shown in Tables 6 to 10 described below. The epoxy resin molding materials for sealing were each molded by means of a transfer molding machine under conditions that the molding temperature was 180° C., the molding pressure was 6.9 MPa, and the curing time was 90 seconds. Post curing was conducted at 180° C. for 5 hours.

(1) Fluidity

A spiral-flow-measuring mold according to the standard of EMMI-1-66 was used to mold each of the epoxy resin molding materials for sealing under the above-mentioned conditions. The flow distance (cm) thereof was obtained.

(2) Hardness in Heated State

Each of the epoxy resin molding materials for sealing was molded into a disc having a diameter of 50 mm and a thickness of 3 mm under the above-mentioned conditions. Immediately after the molding, a Shore D hardness meter was used to measure the hardness thereof.

(3) Storage Stability

Each of the epoxy resin molding materials for sealing was allowed to stand still at 25° C. and 50% RH for 48 hours, and then the spiral flow was measured in the same manner as in the item (1). The storage stability was obtained from the retention ratio between the flow distances before and after the standing.

(4) Flame Retardancy

A mold for molding a test piece 0.16 mm in thickness was used to mold each of the epoxy resin molding materials for sealing under the above-mentioned conditions, and then post-cure the material. In accordance with the UL-94 test method, a flammability test was performed. The total of lingering flame times of the resultant test pieces, the number of which was five, was used as the total lingering flame time thereof so as to evaluate the flame retardancy.

(5) Reflow Resistance

Each of the epoxy resin molding materials for sealing was used to form 80-pin flat packages each having an outside dimension of 20 mm×14 mm×2 mm, wherein silicon chips, 8 mm×10 mm×0.4 mm, were mounted on a copper lead frame under the above-mentioned conditions. The packages were each humidified at 85° C. and 85% RH for 168 hours, and then subjected to reflow treatment at 245° C. for 10 seconds. It was then observed whether the packages were cracked or not. The reflow resistance was evaluated on the basis of the number of cracked packages for the number (10) of the test packages.

(6) Colorability

Each of the epoxy resin molding materials for sealing was molded into a disc having a diameter of 50 mm and a thickness 3 mm under the above-mentioned conditions, and then a spectral calorimeter SE-2000 (manufactured by Nippon Denshoku Industries Co., Ltd.) was used to obtain the L* (luminance) in the L*a*b* color coordinate system in a reflection manner using a C light source at a viewing angle of 2 degrees. The luminance was used as an index of the blackness.

(7) Electric Characteristic

Each of the epoxy resin molding materials for sealing was used to form 176-pin flat packages each having an outside dimension of 20 mm×20 mm×1.4 mm, wherein silicon chips, 8 mm×8 mm×0.4 mm, were mounted on a copper lead frame under the above-mentioned conditions. The electric characteristic was evaluated on the basis of the number of packages wherein a failure based on a short circuit was generated for the number (100) of the test packages.

TABLE 6

| | Example | | | | | |
|---|---|---|---|---|---|---|
| Item | 1 | 2 | 3 | 4 | 5 | 6 |
| Fluidity (cm) | 127 | 132 | 133 | 133 | 133 | 133 |
| Hardness in | 82 | 82 | 82 | 82 | 81 | 81 |
| heated state | | | | | | |
| Storage | 91 | 91 | 91 | 91 | 90 | 90 |
| stability (%) | | | | | | |
| total of | 38 | 40 | 38 | 38 | 36 | 36 |
| lingering flame | | | | | | |
| times (s) | | | | | | |
| Reflow | 0/10 | 0/10 | 0/10 | 0/10 | 0/10 | 0/10 |
| resistance | | | | | | |
| Colorability | 12.3 | 13.7 | 12.3 | 12.3 | 12.6 | 12.6 |
| Electric | 0/1000 | 0/1000 | 0/1000 | 0/1000 | 0/1000 | 0/1000 |
| characteristic | | | | | | |

TABLE 7

| | Example | | | | | |
|---|---|---|---|---|---|---|
| Item | 7 | 8 | 9 | 10 | 11 | 12 |
| Fluidity (cm) | 132 | 133 | 124 | 122 | 142 | 137 |
| Hardness in | 82 | 81 | 80 | 84 | 85 | 84 |
| heated state | | | | | | |
| Storage | 91 | 90 | 91 | 90 | 93 | 93 |
| stability (%) | | | | | | |
| total of | 38 | 36 | 39 | 28 | 33 | 37 |
| lingering flame | | | | | | |
| times (s) | | | | | | |
| Reflow | 0/10 | 0/10 | 0/10 | 0/10 | 1/10 | 1/10 |
| resistance | | | | | | |
| Colorability | 12.3 | 11.7 | 11.6 | 12.5 | 12.2 | 12.3 |
| Electric | 0/1000 | 0/1000 | 0/1000 | 0/1000 | 0/1000 | 0/1000 |
| characteristic | | | | | | |

TABLE 8

| | Example | | | | | |
|---|---|---|---|---|---|---|
| Item | 13 | 14 | 15 | 16 | 17 | 18 |
| Fluidity (cm) | 134 | 129 | 141 | 134 | 129 | 142 |
| Hardness in | 83 | 81 | 84 | 82 | 82 | 82 |
| heated state | | | | | | |
| Storage | 93 | 95 | 99 | 100 | 90 | 90 |
| stability (%) | | | | | | |
| total of | 40 | 30 | 43 | 30 | 21 | 11 |
| lingering flame | | | | | | |
| times (s) | | | | | | |
| Reflow | 1/10 | 0/10 | 0/10 | 0/10 | 2/10 | 0/10 |
| resistance | | | | | | |
| Colorability | 12.5 | 12.1 | 11.9 | 11.8 | 12.9 | 12.9 |
| Electric | 0/1000 | 0/1000 | 0/1000 | 0/1000 | 0/1000 | 0/1000 |
| characteristic | | | | | | |

TABLE 9

| | Comparative Example | | | | | | |
|---|---|---|---|---|---|---|---|
| Item | 1 | 2 | 3 | 4 | 5 | 6 | 7 |
| Fluidity (cm) | 120 | 114 | 131 | 120 | 116 | 128 | 122 |
| Hardness in | 82 | 84 | 85 | 83 | 81 | 84 | 82 |
| heated state | | | | | | | |
| Storage | 90 | 90 | 93 | 93 | 95 | 98 | 100 |
| stability (%) | | | | | | | |
| total of | 34 | 28 | 33 | 40 | 37 | 43 | 34 |
| lingering | | | | | | | |
| flame times (s) | | | | | | | |
| Reflow | 0/10 | 0/10 | 2/10 | 1/10 | 0/10 | 0/10 | 0/10 |
| resistance | | | | | | | |
| Colorability | 14.7 | 13.5 | 13.5 | 14.0 | 14.0 | 13.4 | 13.4 |
| Electric | 3/1000 | 5/1000 | 4/1000 | 2/1000 | 2/1000 | 1/1000 | 1/1000 |
| characteristic | | | | | | | |

TABLE 10

| | Comparative Example | | | | |
|---|---|---|---|---|---|
| Item | 8 | 9 | 10 | 11 | 12 |
| Fluidity (cm) | 121 | 116 | 135 | 117 | 122 |
| Hardness in | 82 | 84 | 85 | 81 | 82 |
| heated state | | | | | |
| Storage | 91 | 90 | 93 | 95 | 100 |
| stability (%) | | | | | |
| total of | 38 | 28 | 33 | 30 | 30 |
| lingering | | | | | |
| flame times (s) | | | | | |
| Reflow | 0/10 | 0/10 | 1/10 | 0/10 | 0/10 |
| resistance | | | | | |
| Colorability | 13.2 | 13.4 | 13.1 | 13 | 12.7 |
| Electric | 0/1000 | 0/1000 | 0/1000 | 0/1000 | 0/1000 |
| characteristic | | | | | |

Comparative Examples 1 to 7, wherein no colorant resin mixture (C) in the invention was contained, were each poor in the fluidity, colorability and electric characteristic. Comparative Examples 8 to 12, wherein pitch was contained but no colorant resin mixture (C) was contained, were each poor in the fluidity and colorability.

On the other hand, Examples 1 to 18 were excellent in the fluidity and colorability. For example, in the storage stability, flame retardancy, reflow resistance, and electric characteristic, Examples 1, 10, 11, and 13 to 16 were substantially equivalent to or superior to Comparative Examples having the same resin compositions except the colorant resin mixture (C) as respective Examples.

### INDUSTRIAL APPLICABILITY

The epoxy resin molding material of the invention for sealing is good in fluidity, curability and colorability. Even when the material is used as a sealing material in electronic component devices wherein the distance between pads or wires is small, the electronic component devices give excellent electric characteristics. Thus, the material has a large industrial value.

1. An epoxy resin molding material for sealing, comprising:
an epoxy resin (A),
a curing agent (B), and
a colorant resin mixture (C) wherein a resin (C1) and a colorant (D) having an electric resistivity of 1×10⁵Ω·cm or more are beforehand mixed with each other.

2. The epoxy resin molding material for sealing according to claim 1, wherein the resin (C1) in the colorant resin mixture (C) is at least one of the epoxy resin (A) and the curing agent (B).

3. The epoxy resin molding material for sealing according to claim 1, further comprising a colorant (D) which gives an electric resistivity of 1×10⁵Ω·cm or more by itself.

4. The epoxy resin molding material for sealing according to claim 1, wherein the colorant (D) is one or more selected from pitch, phthalocyanine dyes, phthalocyanine pigments, aniline black, perylene black, black iron oxide, and black titanium oxide.

5. The epoxy resin molding material for sealing according to claim 4, wherein the colorant (D) is pitch.

6. The epoxy resin molding material for sealing according to claim 4, wherein the pitch is made of a mesophase microspheres separated from mesophase pitch.

7. The epoxy resin molding material for sealing according to claim 4, wherein the carbon content by percentage in the pitch is from 88 to 96% by mass.

8. The epoxy resin molding material for sealing according to claim 4, wherein the amount of the pitch in the colorant resin mixture (C) is 30% or more by mass of the total of the colorant (D) in the colorant resin mixture (C).

9. The epoxy resin molding material for sealing according to claim 1, wherein the amount of the colorant in the colorant resin mixture (C) is 50% or more by mass of the total of the colorant (D) in the epoxy resin molding material.

10. The epoxy resin molding material for sealing according to claim 1, wherein the total amount of the colorant (D) is from 2 to 20 parts by mass for 100 parts by mass of the epoxy resin (A).

11. The epoxy resin molding material for sealing according to claim 1, wherein the epoxy resin (A) is one or more selected from biphenyl type epoxy resin, bisphenol F type epoxy resin, thiodiphenol type epoxy resin, phenol/aralkyl type epoxy resin, and naphthol/aralkyl type epoxy resin.

12. The epoxy resin molding material for sealing according to claim 1, wherein the curing agent (B) is one or more selected from phenol/aralkyl resin and naphthol/aralkyl resin each represented by the following general formula (I) or (II): 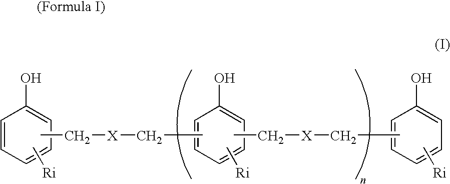
wherein Rs are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10, and 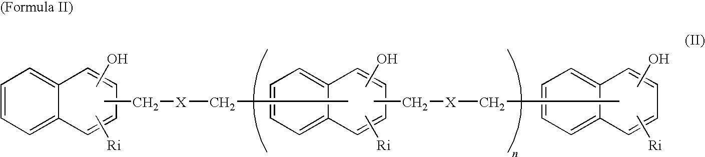
wherein Rs are selected from hydrogen atoms, and substituted or unsubstituted monovalent hydrocarbon groups having 1 to 12 carbon atoms, and may be wholly the same or different; i represents 0 or an integer of 1 to 3; X or Xs (each) represent an aromatic-ring-containing bivalent organic group; and n represents 0 or an integer of 1 to 10.

13. An electronic component device, equipped with an element sealed with the epoxy resin molding material for sealing according to claim 1.

14. The epoxy resin molding material for sealing according to claim 2, further comprising a colorant (D) which gives an electric resistivity of 1×10⁵Ω·cm or more by itself.

15. The epoxy resin molding material for sealing according to claim 4, wherein the pitch is made of a mesophase microspheres separated from mesophase pitch.
